(19) United States
(12) Patent Application Publication
(10) Pub. No.: US 2007/0201191 A1
(43) Pub. Date: Aug. 30, 2007

(54) FIXING MEMBER AND FIXING MEMBER MOUNTING STRUCTURE

(75) Inventors: Shinji TAKAHASHI, Aichi-ken (JP); Yoshiaki KATO, Aichi-ken (JP); Harehide SASAKI, Aichi-ken (JP); Katsumasa MATSUOKA, Aichi-ken (JP); Hiroshi KOBAYASHI, Okazaki-shi (JP)

Correspondence Address: ROBERTS, MLOTKOWSKI & HOBBES, P. O. BOX 10064, MCLEAN, VA, 22102-8064, US

(73) Assignee: KABUSHIKI KAISHA TOKAI-RIKA-DENKI-SEISAKUSHO, Aichi-ken (JP)

(21) Appl. No.: 11/679,702

(22) Filed: Feb. 27, 2007

(30) Foreign Application Priority Data
Feb. 28, 2006 (JP) 2006-053056

(51) Int. Cl. H02B 1/00

(52) U.S. Cl. 361/600

(57) ABSTRACT

A fixing member is used for fixing a case to a printed circuit board. The fixing member is mounted at a mount-receiving portion, which is formed at the case, by being inserted along a side wall of the mount-receiving portion. At the fixing member, a plate spring portion is formed at a predetermined position. The plate spring portion projects to a side of abutting against the side wall. In the state in which the fixing member is mounted at the mount-receiving portion, the plate spring portion is pressed by the side wall and flexes. Consequently, the fixing member is subject to a pressure force in a direction away from the side wall. In addition, the fixing member is supported from a rear face side by support portions which structure the mount-receiving portion. Thus, the fixing member is gripped in a direction intersecting the side wall.

### CROSS-REFERENCE TO RELATED APPLICATION

This application claims priority under 35 USC 119 from Japanese Patent Application No. 2006-053056, the disclosure of which is incorporated by reference herein.

### BACKGROUND OF THE INVENTION

1. Field of the Invention

The present invention relates to a fixing member which is used for fixing a fixed member to a printed circuit board, and to a mounting structure of the fixing member.

2. Description of the Related Art

Numerous electronic components are mounted at a printed circuit board (PCB). Such an electronic component must be fixed to the printed circuit board. In order to do this, often, a fixing member is attached to a case retaining the electronic component and the fixing member is fixed to the printed circuit board by soldering (see, for example, the following patent references: Japanese Utility Model Application Publication (JP-U) No. 5-15347, JP-U No. 63-117064, JP-U No. 6-17130, JP-U No. 7-8984, Japanese Patent Application Laid-Open (JP-A) No. 9-274975, JP-A No. 10-270107 and JP-A No. 2002-164100).

At such a case, a mount-receiving portion for mounting the fixing member is formed. At each of two breadth direction side walls of the fixing member, pawl portions are formed for anchoring at each of two breadth direction inner walls of the mount-receiving portion by frictional force.

To describe a specific example, as shown in FIG. 9A and FIG. 9B, an example of a previously known fixing member 110 has breadth direction side walls 116A and 116B. At the breadth direction side walls 116A and 116B, respectively, pawl portions 118A and 118B are protrudingly provided for anchoring at each of two breadth direction inner walls (for example, a width direction inner wall 124A) of a mount-receiving portion 122 by frictional force. Distal ends of the pawl portions 118A and 118B are formed in tapered shapes. These distal ends press against the breadth direction inner walls. Thus, a state in which the fixing member 110 is mounted at the mount-receiving portion 122 is maintained.

Thus, in a state in which the fixing member 110 has been mounted to a case 120, the distal ends of the pawl portions 118A and 118B abut against the two width direction inner walls of the mount-receiving portion 122. Therefore, looseness of the fixing member 110 in a breadth direction X will not occur.

However, in this structure, breadth direction end portions 111A and 111B of the fixing member 110 are inserted, respectively, into recess portions 123A and 123B which are formed at two breadth direction side portions of the mount-receiving portion 122. Accordingly, in the mounted state, a gap L in a thickness direction Z at the recess portions 123 of the mount-receiving portion 122 is slightly larger than a plate thickness t (a thickness in the thickness direction Z) of the fixing member 110. Therefore, in the mounted state, the fixing member 110 is susceptible to looseness in the thickness direction Z.

### SUMMARY OF THE INVENTION

An object of the present invention, in consideration of the circumstances described above, is to provide a fixing member which prevents looseness in a state in which the fixing member has been mounted to a fixed member, and a mounting structure of the fixing member.

An invention of a first aspect is a fixing member to be used for fixing a fixed member to a printed circuit board, the fixing member being mounted along a side wall of the fixed member at a mount-receiving portion formed at the fixed member, and the fixing member including at least one resilient portion capable of resilient deformation in a direction intersecting the side wall, the at least one resilient portion being formed at a predetermined position at the side wall side of the fixing member, wherein, in a state in which the fixing member has been mounted at the mount-receiving portion, the resilient portion is subject to a reaction force from the side wall and is subject to a pressure force in a direction away from the side wall, and the fixing member is subject to a support force from the mount-receiving portion in a direction toward the side wall.

Thus, with the invention of the first aspect, the at least one resilient portion, which is capable of resilient deformation in the direction intersecting the side wall, is formed at the predetermined position so as to protrude toward the side wall. The resilient portion may be plurally provided, and a number thereof is not particularly limited.

When the fixing member is mounted to the mount-receiving portion, the resilient portion is pressed against the side wall and flexes. Therefore, the fixing member is subject to the pressing force in the direction away from the side wall, and the fixing member is subject to the support force, from the mount-receiving portion, in the direction toward the side wall. Hence, in the state in which the fixing member has been mounted to the mount-receiving portion, looseness in the direction intersecting the side wall is prevented.

In an invention of a second aspect, pawl portions are not protrudingly provided at two breadth direction side walls.

Thus, breadth direction inner walls of the mount-receiving portion of the fixed member will not be scraped by pawl portions as heretofore. Therefore, scraping shavings will not be generated at the time of mounting the fixing member to the fixed member.

In an invention of a third aspect, only one resilient portion is formed, the resilient portion being formed at a central position of a supported portion which is subject to the support force from the mount-receiving portion.

Thus, it is simple to form a structure in which the support force is uniformly applied to the supported portion. Therefore, it is simple to thoroughly prevent looseness of the fixing member in a thickness direction.

In an invention of a fourth aspect, the resilient portion includes a plate spring portion formed so as to project to the side wall side, wherein the plate spring portion is joined, at an end portion at a side thereof that is closer to the printed circuit board, to a main body of the fixing member, and the plate spring portion progressively, from the end portion at the side closer to the printed circuit board toward an end portion at a side further from the printed circuit board, projects further to the side portion side.

Thus, structure of the resilient portion can be simplified. Further, when the fixing member is being fabricated from a sheet metal member, the plate spring portion to serve as the resilient portion can be formed integrally with the fixing member. Thus, fabrication time, fabrication costs and the like are greatly reduced.

An invention of a fifth aspect further includes arm portions which respectively include the two breadth direction side walls, the arm portions being formed by respective cutouts being formed between the resilient portion and the two breadth direction side walls, wherein, when the fixing member is mounted at the mount-receiving portion, the two breadth direction side walls are pressed by two breadth direction inner walls, which are formed at two breadth direction sides of the mount-receiving portion, and the arm portions flex.

Thus, because the arm portions are subject to reaction forces from the two breadth direction inner walls of the mount-receiving portion, the fixing member is in a state in which the fixing member is gripped from the breadth direction, and a firmer state of retention can be realized.

An invention of a sixth aspect is a fixing member mounting structure including: a fixing member of the fourth or fifth aspect, which is mounted at a fixed member of the first aspect, the fixed member being fixed to the printed circuit board by the fixing member being fixed to the printed circuit board; and a step portion which is formed at the side wall of the mount-receiving portion, wherein the plate spring portion is restricted from moving in a direction away from the printed circuit board by the end portion of the plate spring portion at the side thereof that is further from the printed circuit board abutting against the step portion.

Thus, the fixing member is prevented from moving in a direction of disengaging from the mount-receiving portion (in a direction away from the printed circuit board). In other words, a mounting structure of the fixing member which realizes prevention of disengagement of the fixing member can be formed.

According to the present invention, a fixing member and a fixing member mounting structure which prevent looseness in a state in which the fixing member is mounted to a fixed member can be formed.

### BRIEF DESCRIPTION OF THE DRAWINGS

FIG. 1A is a perspective view of a fixing member relating to a first embodiment.

FIG. 1B is a partial enlarged view of FIG. 1A.

FIG. 2A is a perspective view of a fixing member relating to a second embodiment.

FIG. 2B is a partial enlarged view of FIG. 2A.

FIG. 3A is a perspective view of a fixing member relating to a third embodiment.

FIG. 3B is a partial enlarged view of FIG. 3A.

FIG. 4A is a perspective view of a fixing member relating to a fourth embodiment.

FIG. 4B is a partial enlarged view of FIG. 4A.

FIG. 5A is a rear view of the fixing member relating to the fourth embodiment.

FIG. 5B is a side view of the fixing member relating to the fourth embodiment.

FIG. 5C is a side sectional view viewed in the direction of arrows 5C-5C of FIG. 5A.

FIG. 6A is a partial plan view of the fixing member relating to the fourth embodiment.

FIG. 6B is a front sectional view viewed in the direction of arrows 6B-6B of FIG. 6A.

FIG. 6C is a side sectional view viewed in the direction of arrows 6C-6C of FIG. 6B.

FIG. 7A is a front view of a mounting structure relating to the fourth embodiment.

FIG. 7B is a side sectional view viewed in the direction of arrows 7B-7B of FIG. 7A.

FIG. 8 is a partial enlarged sectional view of the fourth embodiment, showing anchoring of a plate spring portion of the fixing member at a mount-receiving portion of a case.

FIG. 9A is a perspective view of an example of a previously known fixing member.

FIG. 9B is a partial enlarged view of FIG. 9A.

### DETAILED DESCRIPTION OF THE INVENTION

Herebelow, embodiments will be presented and preferred embodiments of the present invention described. From the second embodiment onward, structural elements the same as previously described structural elements will be assigned the same reference numerals, and descriptions thereof will be omitted.

### First Embodiment

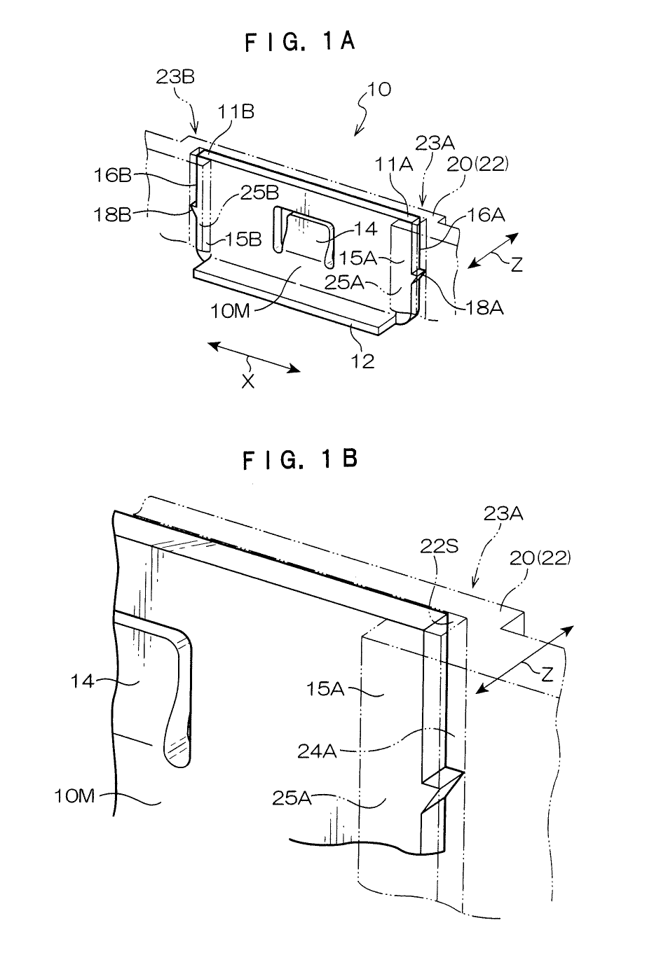

Firstly, a first embodiment will be described. As shown in FIG. 1A and FIG. 1B, a fixing member (fixing peg) 10 relating to the present embodiment is an SMT connector which is used for fixing a case 20, which retains an electronic component, to a printed circuit board.

At the case 20, a mount-receiving portion 22, at which the fixing member 10 is to be mounted, is formed along a side wall 22S. At two breadth direction sides of the mount-receiving portion 22, recess portions 23A and 23B, respectively, are formed in order to retain the two breadth direction sides of the fixing member 10. At the recess portion 23A, a support portion 25A is formed, which supports a supported portion 15A at a rear face side of the fixing member 10. Similarly, at the recess portion 23B, a support portion 25B is formed, which supports a supported portion 15B at a rear face side of the fixing member 10.

At the fixing member 10, an L-shaped leg portion 12 is formed, a surface of which is mounted to the printed circuit board.

Further, at the fixing member 10, a single plate spring portion 14 is formed by punching and bending, at a central position of the case 20 as viewed from a side which abuts against the side wall 22S (that is, a central position of the fixing member 10 as viewed from a front face or rear face thereof). This plate spring portion 14 is integrally formed, at a lower end thereof, to a fixing member main body 10M. The plate spring portion 14 has a form which, in the state in which the fixing member 10 is not mounted at the case 20, progressively, toward an upper portion thereof, projects further from the fixing member main body I OM toward the case 20.

Next, operation of the present embodiment will be described. In order to mount the fixing member 10 at the case 20, a breadth direction end portion 11A and a breadth direction end portion 11B of the fixing member 10 are inserted into, respectively, the recess portions 23A and 23B, leading with the side of the leg portion 12, and the fixing member 10 is inserted into the mount-receiving portion 22 along the side wall 22S of the mount-receiving portion 22. Hence, the fixing member 10 is mounted in a state in which the fixing member 10 is subject to a pressing force in the direction away from the side wall 22S, due to the plate spring portion 14 being pressed and flexed by the side wall 22S, and is subject to a support force in the direction approaching the side wall 22S, due to the support portions 25A and 25B of the mount-receiving portion 22.

Therefore, the fixing member 10 is in a state in which the fixing member 10 is pressed in a thickness direction Z from two sides: the side abutting against the side wall 22S and the side of a rear face therefrom. Thus, looseness in the thickness direction Z in the state in which the fixing member 10 is mounted at the case 20 is prevented.

Furthermore, the plate spring portion 14 is integrally formed at the lower end thereof with the fixing member main body 10M. The plate spring portion 14 has the form with which, in the state in which the plate spring portion 14 is not mounted at the case 20, the plate spring portion 14 progressively, toward the upper portion thereof, projects to the side of the case 20 from the fixing member main body 10M. Because this structure can be assembled by inserting the fixing member 10 into the case 20 from thereabove, the fixing member 10 can be formed such that the insertion operation is easy to carry out.

A pawl portion 18A is protrudingly provided at a breadth direction side wall 16A of the fixing member 10. The pawl portion 18A is anchored by abutting and pressing against a breadth direction inner wall 24A of the mount-receiving portion 22. At a breadth direction side wall 16B at the opposite side therefrom, a pawl portion 18B is protrudingly provided, which anchors at another breadth direction inner wall. Shapes of the pawl portions 18A and 18B are formed, for example, with distal ends thereof being tapered. The fixing member 10 is gripped in a breadth direction X because of the pawl portions 18A and 18B, further preventing looseness in the breadth direction X.

Moreover, the plate spring portion 14 is formed integrally with the fixing member 10 by punching and bending a sheet metal member. Thus, structure of the fixing member 10 can be simplified, and fabrication time, fabrication costs and the like can be greatly cut down.

### Second Embodiment

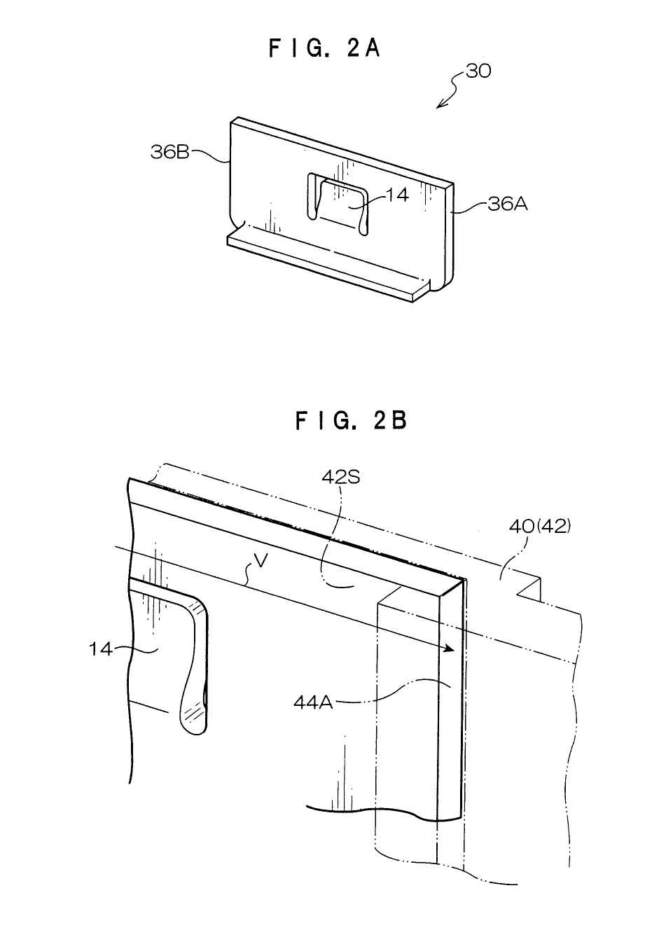

Next, a second embodiment will be described. As shown in FIG. 2A and FIG. 2B, at a fixing member 30 relating to the present embodiment, in contrast with the first embodiment, pawl portions are not formed as heretofore at breadth direction side walls 36A and 36B (two breadth direction side walls 36). Furthermore, the present embodiment contrasts with the first embodiment in that a spacing V between breadth direction inner walls of a mount-receiving portion 42 of a case 40 is narrower by an amount corresponding to the non-formation of the pawl portions.

In the present embodiment, when the fixing member 30 is mounted to the mount-receiving portion 42 of the case 40, the plate spring portion 14 is pressed and flexed by a side wall 42S of the mount-receiving portion 42. Hence, the fixing member 30 is in a state of being gripped in the mount-receiving portion 42 between the side abutting against the side wall 42S and the side of a rear face therefrom. Therefore, even though the pawl portions are not formed at the breadth direction side walls 36A and 36B of the fixing member 30, looseness of the fixing member 30 in the state in which the fixing member 30 is mounted at the case 40 is prevented.

According to the present embodiment, in addition to effects provided by the first embodiment, apart from effects due to the pawl portions, when the fixing member 30 is mounted at the case 40, the two breadth direction inner walls of the mount-receiving portion 42 (for example, a breadth direction inner wall 44A) will not be scraped by pawl portions. Therefore, an effect can be realized in that scraping shavings will not be generated when the fixing member 30 is being mounted to the case 40. Furthermore, an effect can be realized in that when the fixing member 30 is being mounted to the mount-receiving portion 42, even if the fixing member 30 is inserted at an angle with respect to the mount-receiving portion 42, a case of the inner walls of the mount-receiving portion 42 being excessively scraped and an insertion pressure margin being insufficient, as has happened heretofore, will not occur, and a situation in which the fixing member 30 more easily disengages from the mount-receiving portion 42 will not arise.

### Third Embodiment

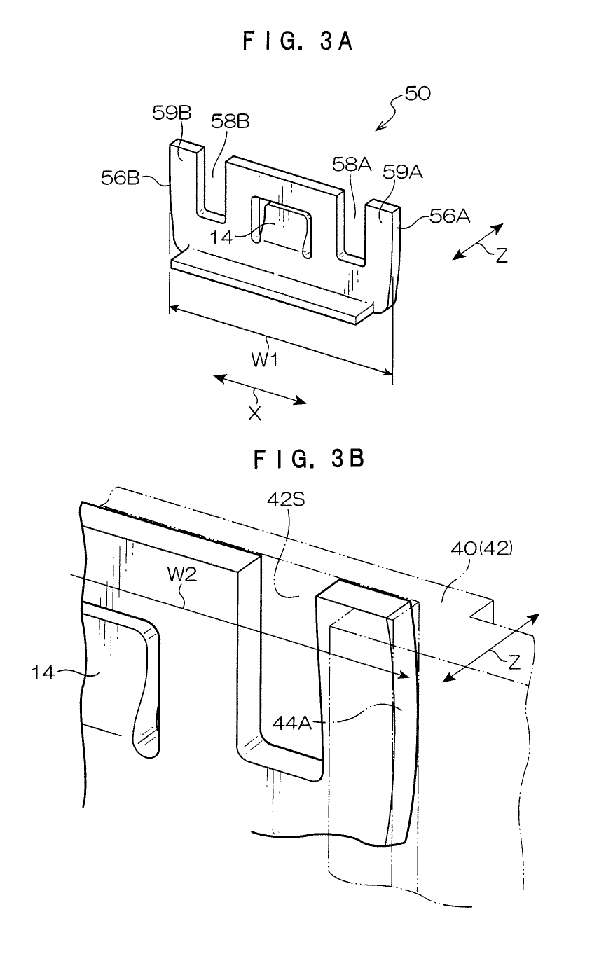

Next, a third embodiment will be described. As shown in FIG. 3A and FIG. 3B, at a fixing member 50 relating to the present embodiment, in contrast with the second embodiment, cutouts 58A and 58B are formed between the plate spring portion 14 and, respectively, breadth direction side walls 56A and 56B (two breadth direction side walls 56). Thus, arm portions 59A and 59B which extend from downward to upward are formed at the fixing member 50, at breadth direction outer sides of the cutouts 58A and 58B. Here, a distance W1 between the breadth direction side walls 56A and 56B is set to be slightly greater than a spacing W2 between the two breadth direction inner walls of the mount-receiving portion 42. Further, the breadth direction side walls 56A and 56B are formed with gently curving convex shapes without conventional pawl portions being formed thereat.

When the fixing member 50 is mounted to the mount-receiving portion 42 of the case 40, the breadth direction side walls 56A and 56B formed with the gently curving convex shapes are smoothly pressed by the respective breadth direction inner walls of the mount-receiving portion 42. Here, the breadth direction side wall 56A being pushed by the breadth direction inner wall 44A is shown in FIG. 3B, and the breadth direction side wall 56B is smoothly pushed by the breadth direction inner wall at the opposite side. Consequently, the arm portions 59A and 59B are respectively flexed toward inner sides in the breadth direction X of the fixing member 50.

Thus, even though the pawl portions 18A and 18B described for the first embodiment (see FIG. 1A and FIG. 1B) are not formed at the breadth direction side walls 56A and 56B, the fixing member 50 is gripped in the breadth direction X by the mount-receiving portion 42. Therefore, scraping shavings will not be generated from the breadth direction inner wall 44A of the mount-receiving portion 42 (and scraping shavings will not be generated at the inner wall at the side opposite from the breadth direction inner wall 44A), the fixing member 50 can be mounted into a state in which the fixing member 50 is gripped in both the thickness direction Z and the breadth direction X, and looseness can be prevented in both the thickness direction Z and the breadth direction X.

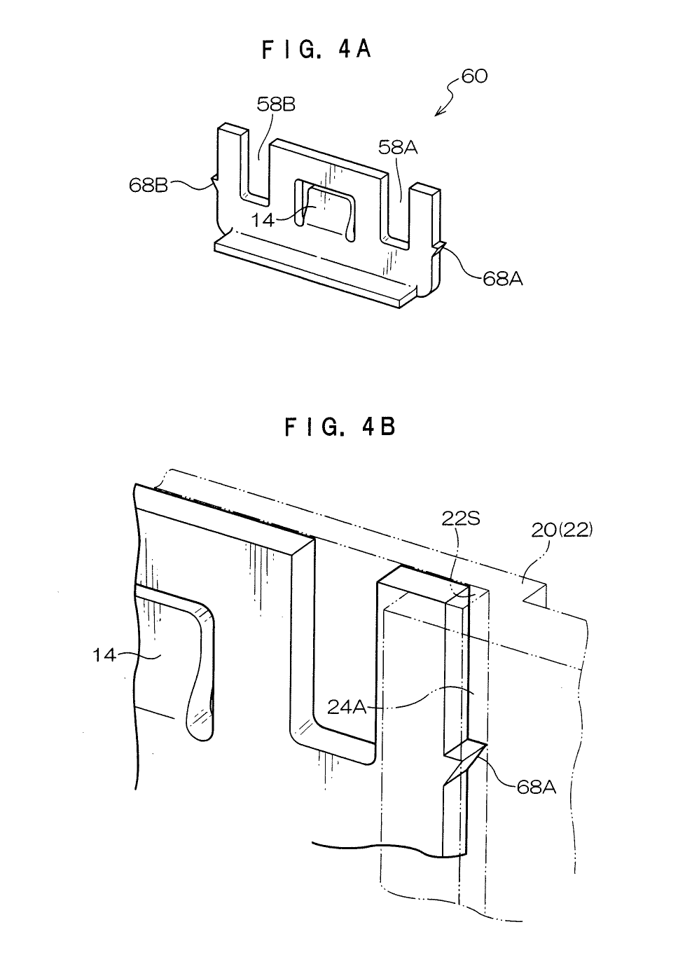

Now, as shown in FIG. 4A and FIG. 4B, a fixing member 60 may be formed at which pawl portions 68A and 68B, which are similar to the pawl portions 18A and 18B, are formed at the two breadth direction side walls. Accordingly, when the fixing member 60 is mounted at the mount-receiving portion 22 of the case 20, scraping shavings will be generated by the pawl portions 68A and 68B, but the fixing member 60 can be more firmly retained at the mount-receiving portion 22.

### Fourth Embodiment

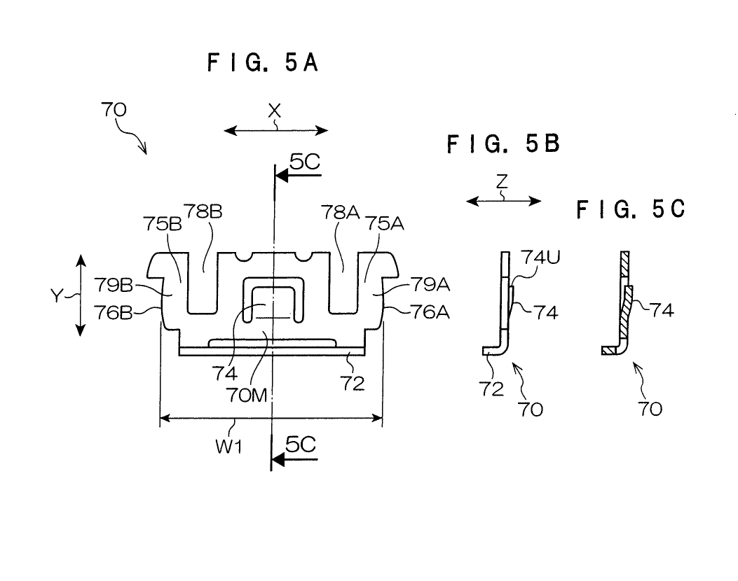

Now, a fourth embodiment will be described. As shown in FIG. 5A to FIG. 5C, a fixing member 70 relating to the present embodiment is a member for which the fixing member 50 relating to the third embodiment (see FIG. 3A and FIG. 3B) is deformed and made easier to use. Herebelow, the fixing member 70 and a mounting structure 100, with which the fixing member 70 is mounted to a mount-receiving portion 82 of a case 80, will be described in detail using FIG. 5A to FIG. 8.

At the case 80, the mount-receiving portion 82 into which the fixing member 70 is to be mounted is formed along a side wall 82S. Protrusion portions 83A and 83B for retaining the two breadth direction sides of the fixing member 70 are formed, respectively, at the two breadth direction sides of the mount-receiving portion 82. A support portion 85A, which supports a supported portion 75A at the rear face side of the fixing member 70, is formed at the protrusion portion 83A. Similarly, at the protrusion portion 83B, a support portion 85B is formed which supports a supported portion 75B at the rear face side of the fixing member 70. Here, the supported portions 75A and 75B are formed by later-described arm portions 79A and 79B, respectively.

A leg portion 72, a surface of which is to be mounted to the printed circuit board, is also formed at the fixing member 70. The leg portion 72 is formed by bending.

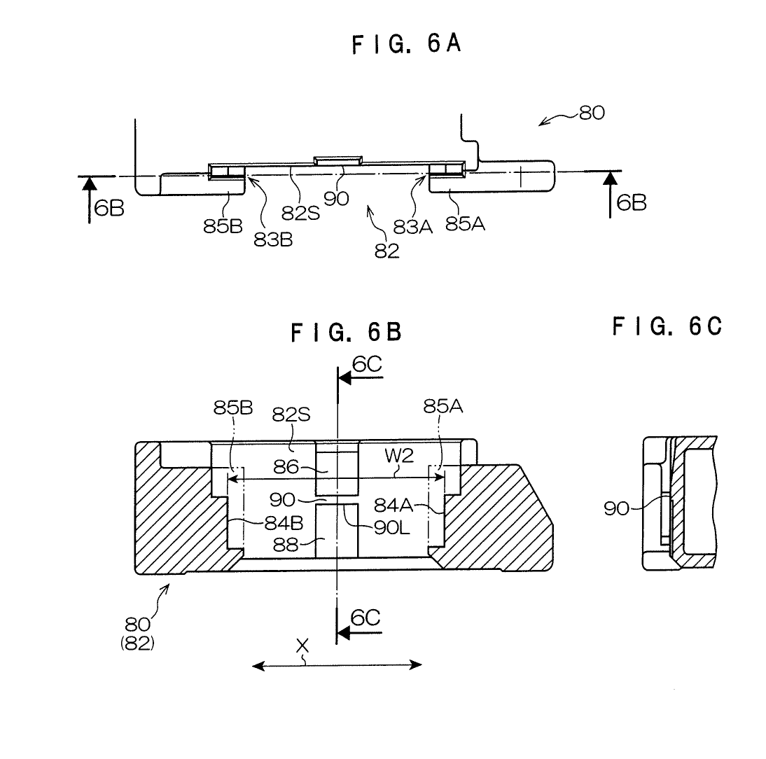

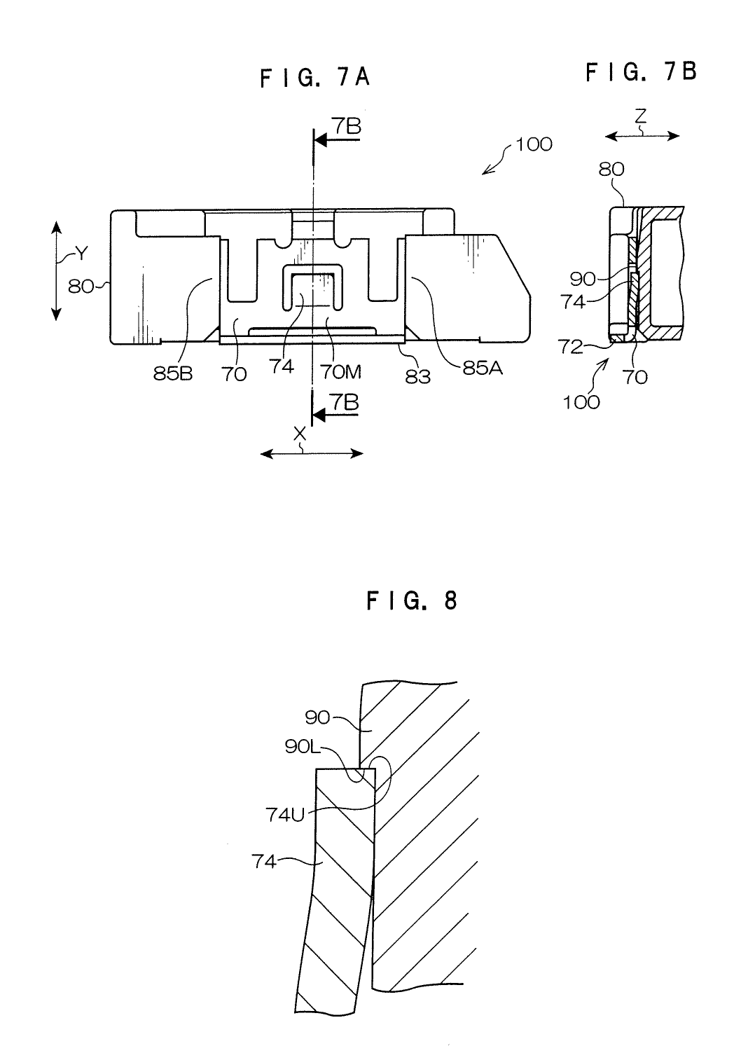

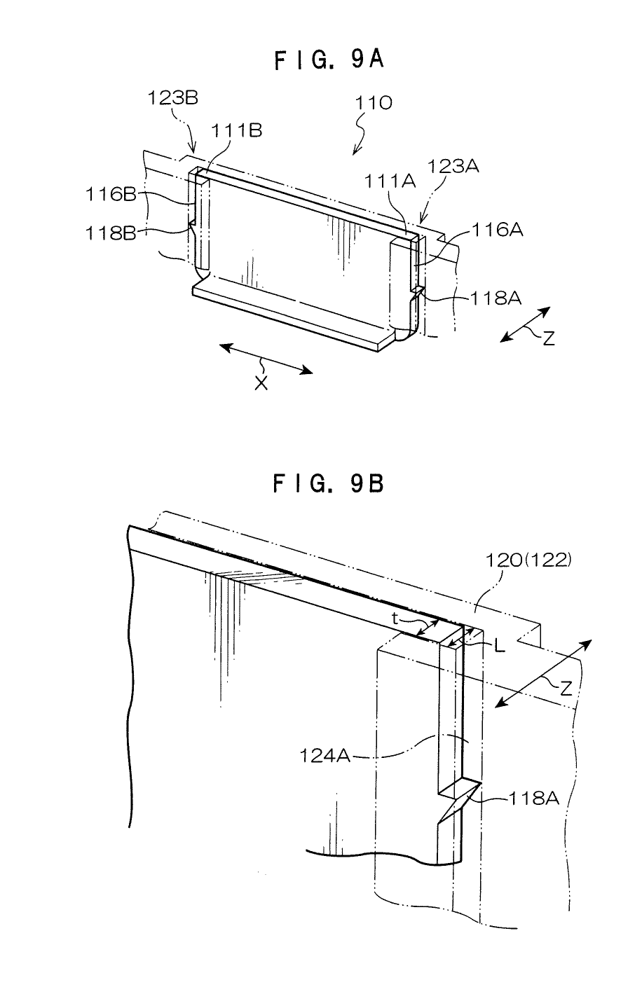

A plate spring portion 74 is also formed at the fixing member 70, at a position central to the supported portions 75A and 75B at the rear face side. A number of the plate spring portion 74 is set to only one. The plate spring portion 74 is formed by punching and bending. The plate spring portion 74 is integrally formed, at a lower end thereof, to a fixing member main body 70M. The plate spring portion 74 has a form which, in the state in which the fixing member 70 is not mounted at the case 80, progressively, toward an upper portion thereof, projects further from the fixing member main body 70M toward the case 80. In the state in which the fixing member 70 is mounted at the case 80, similarly to the first to third embodiments, occurrences of looseness of the fixing member 70 in the thickness direction Z are prevented by the reaction force that the plate spring portion 74 is subject to and the support force that the fixing member 70 receives from the support portions 85A and 85B (see FIG. 6B and FIG. 7B).

Further, cutouts 78A and 78B are formed at the fixing member 70, between the plate spring portion 74 and breadth direction side walls 76A and 76B, respectively. Thus, the arm portions 79A and 79B which extend from downward to upward are formed at the fixing member 70, at breadth direction outer sides of the cutouts 78A and 78B. Here, a distance WI between the breadth direction side walls 76A and 76B is set to be slightly greater than a spacing W2 between two breadth direction inner walls 84A and 84B of the mount-receiving portion 42. Further, similarly to the third embodiment, the breadth direction side walls 76A and 76B of the fixing member 70 are formed with gently curving convex shapes without conventional pawl portions being formed thereat. With this structure, when the fixing member 70 is mounted at the mount-receiving portion 82, the breadth direction side walls 76A and 76B are pressed by the breadth direction inner walls 84A and 84B, respectively, of the mount-receiving portion 82, and the arm portions 79A and 79B flex. Thus, a mounting position in the breadth direction (a left-right direction) is corrected, and looseness in the breadth direction will be prevented.

An upper recess portion 86 and a lower recess portion 88 are formed in the side wall 82S of the mount-receiving portion 82, at positions at which the plate spring portion 74 sequentially abuts when the fixing member 70 is being mounted. Further, by the upper recess portion 86 and the lower recess portion 88 being formed, a division portion 90, which forms a step from the lower recess portion 88, is formed between the upper recess portion 86 and the lower recess portion 88. With this structure, when the fixing member 70 is mounted at the mount-receiving portion 82, an upper end portion of the plate spring portion 74 is anchored at a lower end of the division portion 90. Here, the upper recess portion 86 has a form substantially corresponding to the plate spring portion 74.

Next, operation of the present embodiment will be described. In order to mount the fixing member 70 at the case 80, the arm portions 79A and 79B of the fixing member 70 are inserted into, respectively, the protrusion portions 83A and 83B from the side of the leg portion 72, and the fixing member 70 is inserted into the mount-receiving portion 82 along the side wall 82S of the mount-receiving portion 82 of the case 80.

During the insertion, the plate spring portion 74 is pressed by the division portion 90 and flexes. When the fixing member 70 has been inserted to a position which is a lowermost end, an upper end portion of the plate spring portion 74 reaches to a lower side relative to the division portion 90. The plate spring portion 74 abuts against the side wall of the case at the lower side of the division portion 90, and an upper end 74U of the plate spring portion 74 abuts against a lower end 90L of the division portion 90. Therefore, as shown in FIG. 7A, FIG. 7B and FIG. 8, the plate spring portion 74 is subject to pressure force from the lower recess portion 88 of the mount-receiving portion 82 and flexes, and is anchored at the division portion 90. Further, the fixing member 70 is subject to a support force in a direction approaching the side wall 82S, from the support portions 85A and 85B of the mount-receiving portion 82, which acts to oppose the reaction force that the plate spring portion 74 is subject to.

Therefore, the fixing member 70 is in a state in which the fixing member 70 is pressured in the thickness direction Z from two sides (the side abutting against the lower recess portion 88 and the rear side therefrom) and is retained in the mount-receiving portion 82. Hence, in the state in which the fixing member 70 is mounted to the case 80, looseness in the thickness direction Z is prevented.

Moreover, because only one plate spring portion 74 is formed, at the position central to the supported portions 75A and 75B at the rear face side, the fixing member 70 is gripped in the thickness direction Z with good balance by the support forces from the supported portions 75A and 75B and the reaction force from the plate spring portion 74, and it is easy to thoroughly prevent looseness of the fixing member 70 in the thickness direction Z.

Further, because the fixing member 70 is anchored at the mount-receiving portion 82 of the case 80 by the upper end 74U of the plate spring portion 74 abutting against the lower end 90L of the division portion 90, the mounting structure 100 can be formed, which prevents the fixing member 70 from disengaging upward from the case 80 (in the Y direction). Further, when the fixing member 70 is mounted at the mount-receiving portion 82, the breadth direction side walls 76A and 76B are pressured by the breadth direction inner walls 84A and 84B, respectively, of the mount-receiving portion 82, and the arm portions 79A and 79B flex toward the sides of the cutouts 78A and 78B, respectively. Thus, a state can be maintained in which the fixing member 70 is firmly retained at the mount-receiving portion 82 with respect to three directions: the thickness direction Z, the vertical direction Y and the breadth direction X.

The breadth direction side walls 76A and 76B of the fixing member 70 are formed in curved convex shapes, and pawl portions are not formed as heretofore. Therefore, when the fixing member 70 is being mounted to the case 80, the inner walls of the mount-receiving portion 82 will not be scraped, and thus scraping shavings will not be generated at the time of mounting the fixing member 70 to the case 80. Moreover, the breadth direction side walls 76A and 76B which are formed in gently curving convex shapes are each smoothly pushed by the breadth direction inner walls 84A and 84B of the mount-receiving portion 82, and thus flexing adjustment of the arm portions 79A and 79B is easily carried out, and the fixing member 70 is easily inserted into the mount-receiving portion 82.

Further still, the upper recess portion 86 is formed at the mount-receiving portion 82 of the case 80 to substantially correspond to the shape of the plate spring portion 74. Therefore, when the fixing member 70 is being mounted into the mount-receiving portion 82, mounting is easy.

Hereabove, embodiments have been presented and preferred embodiments of the present invention have been described, but these embodiments are examples, and various modifications can be realized within a scope not departing from the spirit of the present invention. Obviously, rights to the present invention are not to be limited to the above embodiments.

What is claimed is:

1. A fixing member to be used for fixing a fixed member to a printed circuit board, the fixing member being mounted along a side wall of the fixed member at a mount-receiving portion formed at the fixed member, and the fixing member comprising
at least one resilient portion capable of resilient deformation in a direction intersecting the side wall, the at least one resilient portion being formed at a predetermined position at the side wall side of the fixing member,
wherein, in a state in which the fixing member has been mounted at the mount-receiving portion, the resilient portion is subject to a reaction force from the side wall and is subject to a pressure force in a direction away from the side wall, and is subject to a support force from the mount-receiving portion in a direction toward the side wall.

2. The fixing member of claim 1, wherein pawl portions are not protrudingly provided at two breadth direction side walls of the fixing member.

3. The fixing member of claim 1, wherein only one resilient portion is formed, the resilient portion being formed at a central position of a supported portion which is subject to the support force from the mount-receiving portion.

4. The fixing member of claim 2, wherein only one resilient portion is formed, the resilient portion being formed at a central position of a supported portion which is subject to the support force from the mount-receiving portion.

5. The fixing member of claim 3, wherein the resilient portion comprises a plate spring portion formed so as to project to the side wall side,
wherein the plate spring portion is formed, at an end portion at a side thereof that is closer to the printed circuit board, to a main body of the fixing member, and
the plate spring portion progressively, from the end portion at the side closer to the printed circuit board toward an end portion at a side further from the printed circuit board, projects further to the side portion side.

6. The fixing member of claim 4, wherein the resilient portion comprises a plate spring portion formed so as to project to the side wall side,
wherein the plate spring portion is formed, at an end portion at a side thereof that is closer to the printed circuit board, to a main body of the fixing member, and
the plate spring portion progressively, from the end portion at the side closer to the printed circuit board toward an end portion at a side further from the printed circuit board, projects further to the side portion side.

7. The fixing member of claim 3, further comprising arm portions which respectively include the two breadth direction side walls, the arm portions being formed by respective cutouts being formed between the resilient portion and the two breadth direction side walls,
wherein, when the fixing member is mounted at the mount-receiving portion, the two breadth direction side walls are pressed by two breadth direction inner walls, which are formed at two breadth direction sides of the mount-receiving portion, and the arm portions flex.

8. The fixing member of claim 4, further comprising arm portions which respectively include the two breadth direction side walls, the arm portions being formed by respective cutouts being formed between the resilient portion and the two breadth direction side walls,
wherein, when the fixing member is mounted at the mount-receiving portion, the two breadth direction side walls are pressed by two breadth direction inner walls, which are formed at two breadth direction sides of the mount-receiving portion, and the arm portions flex.

9. A fixing member mounting structure comprising:
the fixing member of claim 5, which is mounted at the fixed member of claim 1, the fixed member being fixed to the printed circuit board by the fixing member being fixed to the printed circuit board;
and a step portion which is formed at the side wall of the mount-receiving portion,
wherein the plate spring portion is restricted from moving in a direction away from the printed circuit board by the end portion of the plate spring portion at the side thereof that is further from the printed circuit board abutting against the step portion.

10. A fixing member mounting structure comprising:
the fixing member of claim 7, which is mounted at the fixed member of claim 1, the fixed member being fixed to the printed circuit board by the fixing member being fixed to the printed circuit board;
and a step portion which is formed at the side wall of the mount-receiving portion,
wherein the plate spring portion is restricted from moving in a direction away from the printed circuit board by the end portion of the plate spring portion at the side thereof that is further from the printed circuit board abutting against the step portion.

11. A fixing member to be used for fixing a fixed member to a printed circuit board, the fixing member being mounted along a side wall of the fixed member at a mount-receiving portion formed at the fixed member, and the fixing member comprising:
at least one resilient portion capable of resilient deformation in a direction intersecting the side wall, the at least one resilient portion being formed at a predetermined position at the side wall side of the fixing member, and the at least one resilient portion including a plate spring portion which is formed so as to project to the side wall side; and
arm portions which include two breadth direction side walls, the arm portions being formed by respective cutouts being formed between the resilient portion and the two breadth direction side walls.
